(19) United States
(12) Patent Application Publication
(10) Pub. No.: US 2008/0315615 A1
(43) Pub. Date: Dec. 25, 2008

(54) ELECTRIC SIDE-WINDOW ROLL-UP SHADE

(75) Inventor: Jan LEKAR, Reichenbach (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: BOS GmbH & Co. KG, Ostfildern (DE)

(21) Appl. No.: 12/141,413

(22) Filed: Jun. 18, 2008

(30) Foreign Application Priority Data
Jun. 19, 2007 (DE) 102007028585.1-42

(51) Int. Cl. B60J 1/20

(52) U.S. Cl. 296/97.4

(57) ABSTRACT

A side-window roll-up shade for the front doors of motor vehicles which has a relatively short wind-up shaft housed in the region of a back edge of the window in the door frame. A short guide rail extends above the top edge of the window for guiding a slide, which is connected to a tip of the roll-up shade. For driving the roll-up shade, an electric drive with a cord is provided, with the cord extending around the window opening as a closed loop.

### CROSS-REFERENCE TO RELATED APPLICATIONS

This patent application claims the benefit of German Patent Application No. 102007028585.1-42, filed on Jun. 19, 2007.

### FIELD OF THE INVENTION

The present invention relates generally to roller shade assemblies, and more particularly, to a motor driven roller shade assembly for the side windows of motor vehicles.

### BACKGROUND OF THE INVENTION

A low-lying sun both at sunrise and also at sunset can lead to glare on the driver according to the orientation of the vehicle to the sun. Glare coming from the front can be prevented by the driver through the use of a conventional sun visor, which is hinged on the ceiling above the windshield that the driver folds down when needed.

The sun shining from the side also can interfere with the driver's vision, and to prevent such side glare it is known to use narrow roll-up sun shades, which are arranged in the upper regions of the side windows. These roll-up shades include wind-up shafts mounted in the door at the back edge of the window frame, that is, in the vicinity of a B-pillar of the vehicle frame. A strip-shaped roll-up shade, which is pulled away from the wind-up shaft and which then shades the upper region of the window, about 20% of the window height, is wound onto the wind-up shaft.

The roll-up shade is wound onto the wind-up shaft with the aid of a spring motor, while the unwinding is effected by hand. The unwound roll-up shade is fixed with the leading edge or tip at the corresponding opposite position on the window frame close to the A-pillar of the vehicle.

Depending on the vehicle type, whether two-door or four-door, for front side windows, the back edge of the window frame lies more or less behind the shoulder of the driver. Accordingly, it is difficult for the driver to grip and pull out the roll-up shade. On the other hand, the space for accommodating the drives for the window shades is very limited, because the width of the window frame should not be increased by the drives.

### OBJECTS AND SUMMARY OF THE INVENTION

It is an object of the present invention to provide a novel, electrically operated side window roll-up shade for front side windows of motor vehicles.

In the novel side window roll-up shade, the wind-up shaft is mounted so that it can rotate in the upper region of the back edge of the window frame. The length of the wind-up shaft is shorter than the relevant, essentially vertical section.

The roll-up shade is fixed at one edge to the windup shaft. It has a free end or a tip away from the wind-up shaft. A guide rail within which a free end of the roll-up shade is guided, extends along the upper edge of the window frame. A spring motor is used for biasing the wind-up shaft in a winding direction for rolling the shade onto the wind-up shaft.

A cord which runs at least in some sections in the window frame and which is fixed to the free end of the roll-up shade is guided around the window. An electric drive motor is provided for setting the cord in motion.

The use of a cord running around the window has the advantage that, independent of the direction of motion, only tensile forces, which must be applied by the electric motor, are exerted on the cord. If the cord were not guided around the window, then only the extension motion of the shade could be achieved with the help of the cord, while the retraction would take place only by the spring motor, which would necessitate the spring motor also being required to overcome the friction force that the cord undergoes. In contrast, in the arrangement according to the invention, the spring motor must apply only the force that is necessary to wind up the roll-up shade or to keep it sufficiently tight during operation. The friction force that the cord undergoes during the return of the roll-up shade is transmitted from the taut cord section or return cord section to the drive motor. The cord has the additional advantage that it can also be effectively deflected around small radius curvatures, like those that appear, for example, in the upper corner of the window frame.

If any return cord section of the cord arrangement according to the invention were missing, which section runs back from the roll-up shade tip in the direction toward the wind-up shaft and from there to the motor, then the working cord section would have to be replaced by an element that is rigid under compression when the resulting friction is to be applied by the motor. Elements that are rigid under compression for driving roll-up shades are known, but generate a relatively large amount of friction. In the case of a small side window roll-up shade, the resulting friction force is disproportionately high, especially when small deflection radius turns are necessary due to other installed components in the door, such as mirrors, etc. The arrangement according to the invention is thus relatively low in friction, also from the viewpoint of the spring motor.

The length of the wind-up shaft is measured according to the permissible height of the bottom edge of the extended roll-up shade and extends between 20% and 40% of the length of the rear side edge of the window, which runs at least approximately vertically. The roll-up shade can have approximately the form of an acute triangle.

The roll-up shade can be provided on its end away from the wind-up shaft with a guide device, which is designed to run in the guide rail. This can involve a type of slide, which is rigidly connected to the cord.

So that the cord always remains sufficiently tight independent of the temperature and the affect of moisture so there is no free travel, it is advantageous if the ends of the cord are connected to each other by means of a tensile spring. Another possibility is for the ends of the cord to be fixed to a rope pulley, wherein, in turn, one end is spring-biased.

The following description of the figures explains the aspects necessary for understanding the invention. Other not-described details can be taken from the drawings in the usual way by someone skilled in the art, which, in this respect, supplement the description of the figures. It is clear that a series of modifications is possible.

The following drawings are not necessarily to scale. For illustrating details, certain features may be shown excessively large. In addition, the drawings are simplified and do not contain each optional detail for practical construction. The terms “top” and “bottom” or “front” and “back” refer to the normal installation positioning or terminology in motor vehicles.

Hence, other objects and advantages of the invention will become apparent upon reading the following detailed description and upon reference to the drawings, in which:

### BRIEF DESCRIPTION OF THE DRAWINGS

FIG. 1 is an inside elevational view of the left door of a motor vehicle having a side window roll-up shade assembly in accordance with the invention;

FIG. 2 is an enlarged fragmentary side elevational view of the motor vehicle door shown in FIG. 1 with the inner lining removed so as to reveal the roll-up shade assembly drive;

FIG. 3 is an enlarged fragmentary perspective a guide rail and movable slide of the illustrated roll-up shade assembly; and

FIG. 4 is an enlarged, exploded view of the drive for the illustrated roll-up shade assembly.

While the invention is susceptible of various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

### DESCRIPTION OF THE PREFERRED EMBODIMENTS

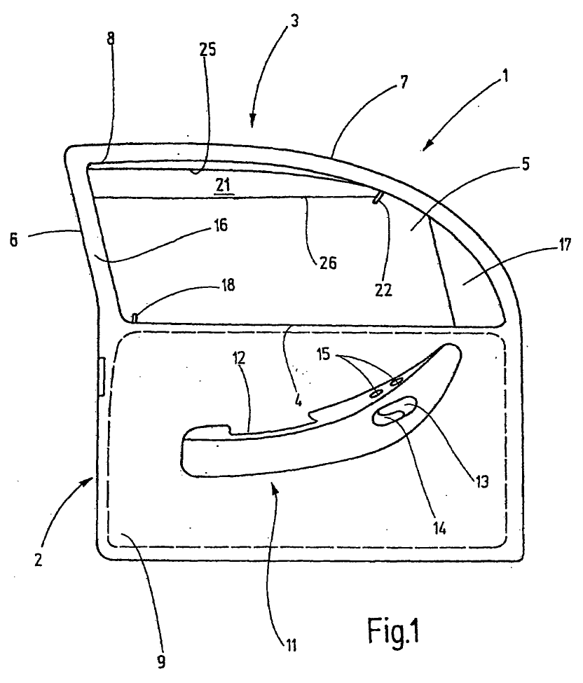

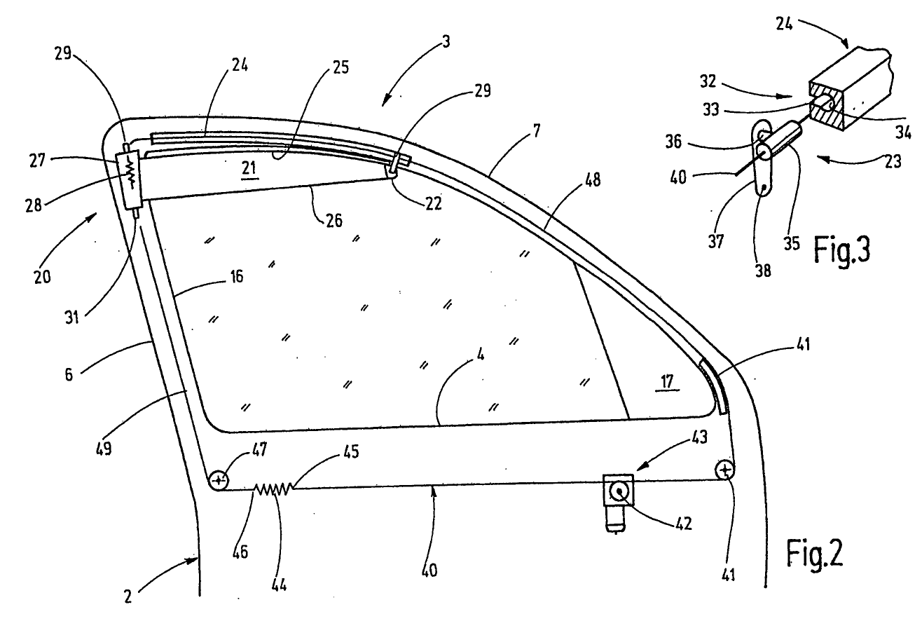

Referring now more particularly to the drawings, there is shown an illustrative motor vehicle door having a side window roll-up shade in accordance with the invention. FIG. 1 shows a view toward the inside of a left front door 1 of a motor vehicle. A lower door body 2 can be seen, over which a window frame 3 spans in an arc shape. Together with a top edge 4 of the door body 2 (FIG. 2), the window frame 3 defines a window opening 5. The frame 3 includes a rear frame part 6 and a top frame part or section 7, which merge together at 8 with an inner edge.

The rear frame part 6 leads from the inner corner 8 to the top edge of the body 2 and opens there into the door body 2. The top frame section 7 leads from the inner corner 8 to the front edge of the door and extends in an arc before it similarly opens into the door body 2.

For purposes herein, when the frame or body is discussed, hollow structures are designated, in which the individual door installed components, such as, loudspeaker, locks, window lifter, pulleys, window rails, and the like, are mounted and guided, without further distinction between the load-bearing sheet metal car body and a possible inner lining. It is clear to someone skilled in the art that both the window frame and also the body have a hollow construction and are made essentially from a sheet metal outer skin and an inner lining 9, between which a load-bearing shell is arranged.

The inner lining 9, on which a door handle arrangement 11 is fixed, forms the predominant part of the visible side of the body 2. The door handle arrangement 11 has a handle recess 12, a lock activating lever 14 mounted in a recess 13 so that it can pivot, and also a switch 15, with which window panes, mirrors, seats, and the like can be adjusted or activated. Another strip-shaped inner lining 16 is provided on the inside of the rear frame section 6.

In the front region of the window cut-out 5, there is a filler plate 17, on which an outside mirror is located, in a known way on the outside and in which an appropriate guide rail for a window pane is provided that cannot be seen in the drawing. A corresponding guide rail is located in the back frame section 6. The guide rails run into the door body 2. Finally, on the top side 4 of the door body 2, a peg 18 is provided, which is used as a door locking knob and which indicates the closed state of the door lock.

The illustrated front door 1 is provided with a side window roll-up shade assembly 20 (FIG. 2) having a roll-up shade 21 shown in an extended position in FIG. 1. As can be seen, the roll-up shade 21 has an approximately triangular blank cut, wherein the wide end is located at the back window-frame section 6, while the tip 22 is connected to a slide 23 which runs in a guide rail 24. The roll-up shade 21 is defined by two edges 25,26, of which at least the edge 26 is straight, while the edge 25 approximately follows the profile of the bottom edge of the frame section 7 and extends almost straight, or alternatively completely straight.

As shown in FIG. 1, in the taut state the roll-up shade 21 extends next to the inside of the window pane close under the approximately horizontal section of the window-frame section 7, wherein practically only a very small gap remains between its bottom edge of the frame section 7 and the roll-up shade edge 25. The bottom edge 26 runs approximately parallel to the top edge 4 of the door body 2 at such a distance that there is still an area that is permissible according to applicable regulations for an unimpaired view to the outside.

The roll-up shade 21 is pulled out through a slot which is located next to the inside of the window pane and which starts from the inner corner 8. The slot is constructed as a recess in the inner lining 6.

The end of the roll-up shade 21 away from the tip 22 is fixed to a wind-up shaft 27, which is mounted so that it can rotate in the back frame section 6 between the sheet metal outer skin and the inner lining sitting on this skin. The wind-up shaft 27 has a frustum-shaped construction, wherein, in FIG. 2, the cone angle is shown greatly exaggerated. With the help of the conical wind-up shaft construction, the tip 22 of the roll-up shade 21 can follow the arc-shaped profile of the top window frame section 6 as it is drawn from the wind-up shaft.

In the interior of the wind-up shaft 27 a spring motor 28 is provided which is fixed on one end against rotation to a bearing journal 29 and on the other end to the wind-up shaft 27. With the assistance of the spring motor 28, the wind-up shaft 27 is biased in a winding up direction of the roll-up shade 21. A bottom bearing journal 31, which is held so that it can rotate in appropriate bearing blocks, corresponds to the bearing journal 29.

The guide rail 24, as depicted in FIG. 3, has a guide groove 32 defined by a groove slot 33 and a groove chamber 34. The width of the slot 33 which is smaller than the diameter of the approximately circular groove chamber 34, produces an undercut guide groove 32.

The guide rail 24 begins in the vicinity of the wind-up shaft 27 and extends close to the distance of the path of travel of the tip 22 when the roll-up shade 21 is completely extended. At that end point, the guide rail 24 lies at the height of the bottom end of the wind-up shaft (27). The attachment means for securing the guide rail 24 to the sheet metal outer skin is not shown in detail since it will be known by a person skilled in the art.

The slide 23, as also depicted in FIG. 3, includes a slide base body 35, which has the shape of a short cylindrical piece adapted for sliding movement in a longitudinal direction through the groove chamber 34 without jamming. Alternatively a dumbbell-shaped slide part could be used.

A short peg 36 to which a plate 37 is attached projects from a side of the slide base body 35 approximately in the center of the body 35. The diameter of the peg 36 corresponds to the groove slot 33 and its length is such that a plate 37 can run outside the guide rail 24. The plate 37 extends downwardly, as shown, from the peg 36 and is formed with an attachment opening 38 at its bottom end to which the tip 22 of the roll-up shade 21 is fixed, for example, with a rivet.

To move the slide 23 along the guide rail 24, a flexible cord 40 is provided, which is connected to the slide base body 35. The cord 40 emerges, for example, at the right end, out of the groove chamber 34 of the guide rail 24 and runs from there via appropriate guide elements to a guide element 41 in the region of the front, bottom corner of the side window 5. The guide element lying in the region between the guide piece 41 and the adjacent end of the guide rail 24 can have a similar construction.

Below the bottom edge 6 of the window and thus within the door body 2, the cord 40 runs around a deflection roller 39 mounted so that it can rotate toward a rope pulley 42 of an electric drive device 43. From the drive device 43, the cord 40 extends to a tension or compensation spring 44 to which it is fixed at one end 45. The cord 40 has a second end 46, which is fixed to the other end of the tension or compensation spring 44. From this end 46, the cord 40 extends to a deflection roller 47, which is located underneath the back, bottom inner corner of the window 5 within the door body 2. From there, the tension cord 40 runs out through the back frame part 6 upwardly in the direction toward the wind-up shaft 27 and above the inner corner 8 and is directed either by a deflection pulley that cannot be seen or a static slide piece, in the direction toward the left or back end of the guide rail 24. Here, the cord 40 is led, in turn, into the guide chamber 34 of the guide rail 24. As can be seen, the cord 40 thereby surrounds the side window 5 completely as a closed ring, excluding any breaks due to the tension spring 44 or attachment points to the rope pulley 42.

The rope pulley 42 divides the cord 40 functionally into a working cord section 48 and a return cord section 49. The working cord section 48 extends between the slide 23 and the rope pulley 42, while the return cord section 49, which contains the compensation spring 44, lies between the rope pulley 42 and similarly the slide 23. In each region, the cord 40 is in tension when the roll-up shade 21 is retracted. The function of the roll-up window shade 20 is explained further below.

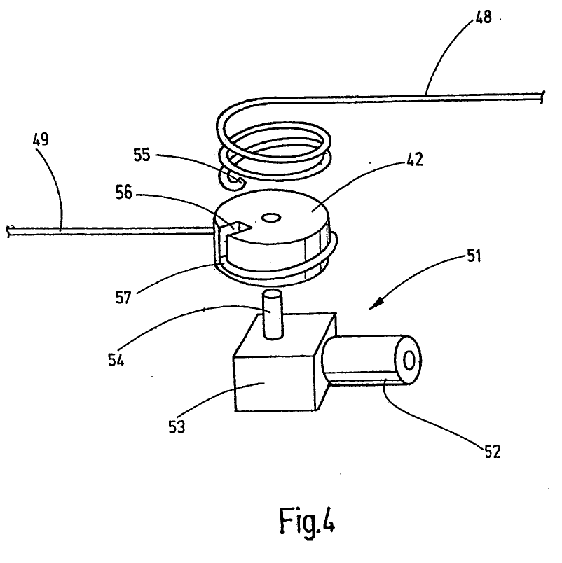

The rope pulley 42 in this case has a non-slip connection with the cord 40, as depicted in FIG. 4. The illustrated drive device 43 includes a gear motor 51 with a permanently excited direct-current motor 52, which drives a gear 53. The rope pulley 42 is fixed to an output shaft 54 of the gear 53. The section of the cord 40 coming from the right and forming the working cord section 48, lies as shown, in several loops around the periphery of the rope pulley 42 and is anchored with its end 55 in an attachment groove 56 of the rope pulley 42. In the same attachment groove 56, the end 57 of the return cord section 49 is held. Because the roll-up shade 21 is extended, the return cord section 49 lies on the rope pulley 42 with only about one winding, while the working cord section 48 is wound with several windings corresponding to the length of the extended roll-up shade 21.

Instead of the illustrated connection of the cord 40 to the rope pulley 42, alternatively the rope pulley 42 may be in the form of a winch, in which the cord 40 runs uncut in two or three loops around the rope pulley 42. In that case, the rope pulley may be provided with a concave groove for holding the existing coil formed from two or three loops centered on the rope pulley 42 and for preventing it from moving in an axial direction in a helical shape.

The function of the foregoing illustrated arrangement is as follows:

In the retracted state, the roll-up shade 21 is wound almost completely onto the wind-up shaft 27 under the bias of the spring motor 28. In this position, the slide 23 with the roll-up shade tip 22 fixed to it is located directed next to the inner edge 16 of the back frame section 6. The cord 40 is held in tension across the entire length by the compensation spring 44. The spring 44 stands at the right in the vicinity of the drive device 43, with respect to the arrangement shown in FIG. 2.

Because the drive device 43 is self-locking, the roll-up shade 20 is locked in the retracted position. The force of the compensation spring 44 maintains both the working cord section and return cord section 48, 49 in tension, i.e., the end 46 is pulled in the direction toward the rope pulley 42.

Starting from this retracted position, if the user wants to extend the roll-up shade 20, then, as depicted in FIG. 2, he can set the drive device 43 to move in the appropriate rotational direction by means of an appropriate switch, for example, the switch 15 in the armrest 11. The rope pulley 42 pulls on the working cord section 48. By means of the working cord section 48, the tensile force of the drive device 43 is transferred to the slide 23, which is pulled from the back end of the guide rail 24, i.e., the left end in FIG. 2, in the direction toward the opposite end. The slide simultaneously pulls the tip 22 of the roll-up shade 21 connected to it and pulls the roll-up shade 21 from the wind-up shaft 27 against the effect of the spring motor 28. Simultaneously, the working cord section 48 applies the tensile force to the return cord section 49 in order to move the return cord section 49 across the corresponding slide positions, for example, in the curved guide rail 24.

For retracting the roll-up shade 21, the drive device 43 is set in motion in the reverse rotational direction, whereby the tensile force now acts via the return cord section 49, which is necessary, however, only for overcoming the friction that the working cord section 48 experiences. No force must be transferred via the return cord section 49 in order to wind up the roll-up shade 21. This work is performed by the spring motor 28 which applies the necessary force. For this reason, the compensation spring 44 lies in the region of the return cord section 49 and not in the region of the working cord section 48, in order to prevent that force that must be transferred via the tension spring 44 in order to pull the roll-up shade 21 from the wind-up shaft 27 from acting against the effect of the spring motor 28.

For the sliding movement, the slide 23 runs with its slide base body 25 through the groove chamber 34. In this chamber, it is guided essentially tilt-proof with respect to its transverse axis. The tilting movement with respect to the longitudinal axis is prevented by the peg 36, which runs in the groove slot 33. The cord force can thus be transmitted directly to the roll-up shade 21, whose tip 22 is carried by the slide 23, i.e., the weight of which is carried via the slide 23 in the guide rail 24.

From the foregoing, a side-window roll-up shade is provided for the front doors of motor vehicles which has a short wind-up shaft housed in the region of the back edge of the window in the door frame. A short piece of a guide rail runs above the top edge of the window for guiding a slide, which is connected to the tip of the roll-up shade. For driving the roll-up shade, an electric drive with a cord is provided, with the cord extending around the window opening as a closed loop.

1. A side-window roll-up shade assembly (20) for motor vehicles having a side window (5) surrounded by a window frame (3) having a top section (7), a bottom section (4), and opposite side sections (6, 7) comprising
a wind-up shaft (27) mountable for rotating in one of the side sections (6) of the window frame (3), said winding shaft (27) having a length shorter than the length of the side section (6) in which it is mounted,
a roll-up shade (21) having one end fixed to the wind-up shaft (27) and a free end (22) away from the wind-up shaft (27),
a guide rail (24) for guiding movement to the free end (22) of the roll-up shade (21),
a spring motor (28) for biasing the wind-up shaft (27) in a direction for winding the roll-up shade (21) onto the wind-up shaft (27),
a cord (40) guided around the window (5) and extending in at least some sections in the window frame (3), said cord (40) being coupled to the free end (22) of the roll-up shade (21), and
an electric drive motor (52) coupled with the cord (40) for moving the cord and wind-up shade.

2. The side-window roll-up shade of claim 1 in which the wind-up shaft (27) has a length of between 20% and 40% of the length side section (6) of the window frame in which it is mounted.

3. The side-window roll-up shade of claim 1 in which the roll-up shade (21) has the approximate shape of an acute triangle.

4. The side-window roll-up shade of claim 1 in which said windup shaft is mountable in the side section of a front side window of a motor vehicle.

5. The side-window roll-up shade of claim 1 in which said roll-up shade (21) has a guide device (23) on its free end (22) away from the wind-up shaft (27) that is moveable in the guide rail (24).

6. The side-window roll-up shade of claim 1 in which said cord (40) includes a tensioning device (44).

7. The side-window roll-up shade of claim 1 in which said cord (40) has ends (45,46) that are connected to each other by means of a tension spring 44.

8. The side-window roll-up shade of claim 1 in which said cord (40) has opposite ends that are fixed to a rope pulley (42).

9. The side-window roll-up shade of claim 1 in which said rope pulley (42) is drivable by said drive motor (25).

10. In a motor vehicle passenger door comprising
a side window (5) surrounded by a window frame (3) having a top section (7), a bottom section (4), and opposite side sections (6, 7).
a side window roll-up shade assembly mounted in said door, said side window roll-up shade assembly including a wind-up shaft (27) mountable for rotating in one of the side sections (6) of the window frame (3), said winding shaft (27) having a length shorter than the length of the side section (6) in which it is mounted,
a roll-up shade (21) having one end fixed to the wind-up shaft (27) and a free end (22) away from the wind-up shaft (27), said roll-up shade (21) being extendable between a retracted wound-up condition and an extended pulled-out position,
a guide rail (24) for guiding movement to the free end (22) of the roll-up shade (21),
a spring motor (28) for biasing the wind-up shaft (27) in a direction for winding the roll-up shade (21) onto the wind-up shaft (27),
a cord (40) coupled to a free end (22) of the roll-up shade (21) and mounted for movement around the side window (5), and
an electric drive motor (52) coupled to said cord (40) for moving the cord and in turn the wind-up shaft for moving said shade to said extended position.

11. In the motor vehicle door of claim 10 in which the wind-up shaft (27) has a length of between 20% and 40% of the length side section (6) of the window frame in which it is mounted.

12. In the motor vehicle door of claim 10 in which the roll-up shade (21) has the approximate shape of an acute triangle.

13. In the motor vehicle door of claim 10 in which the side window is a front side window of the motor vehicle.

14. In the motor vehicle door of claim 10 in which said roll-up shade (21) has a guide device (23) on its free end (22) away from the wind-up shaft (27) that is moveable in the guide rail (24).

15. In the motor vehicle door of claim 10 in which said cord (40) includes a tensioning device (44).

16. In the motor vehicle door of claim 10 in which said cord (40) has ends (45,46) that are connected to each other by means of a tension spring 44.

17. In the motor vehicle door of claim 10 in which said cord (40) has opposite ends that are fixed to a rope pulley (42), and said electric motor being operable for driving said rope pulley to said cord and roll-up shade.

18. In the motor vehicle door of claim 10 in which said rope pulley (42) is drivable by said drive motor (25).
